(19) United States
(12) Patent Application Publication
(10) Pub. No.: US 2008/0257096 A1
(43) Pub. Date: Oct. 23, 2008

(54) Flexible Parallel Manipulator For Nano-, Meso- or Macro-Positioning With Multi-Degrees of Freedom

(76) Inventors: Zhenqi Zhu, Holmdel, NJ (US); Hongliang Cui, West Hartford, CT (US); Kishore Pochiraju, Princeton Junction, NJ (US)

Correspondence Address: GREENBERG TRAURIG, LLP, 200 PARK AVE., P.O. BOX 677, FLORHAM PARK, NJ, 07932, US

(21) Appl. No.: 11/909,852

(22) PCT Filed: Mar. 30, 2006
(86) PCT No.: PCT/US06/11360

§ 371 Date: Sep. 27, 2007

Related U.S. Application Data
(60) Provisional application No. 60/667,794, filed on Apr. 1, 2005.

(51) Int. Cl. B25J 17/00; B25J 18/06; G06F 17/00

(52) U.S. Cl. 74/490.08; 700/245

(57) ABSTRACT

The present invention is a friction- and backlash-fee flexible parallel manipulator device. The device is composed of multiple elastic fiber legs with various physical properties, a top platform, and a bottom platform. With multiple degrees of freedom, the motion of the top platform is controlled by the multiple elastic fiber legs whose lengths or curvatures between the top and bottom platforms are controlled based on the required motion of the top platform. The device can be used for nano-, micro-, or meso-manipulation.

### INTRODUCTION

This application claims benefit of U.S. Provisional Patent Application Ser. No. 60/667,794, filed Apr. 1, 2005, the contents of which are incorporated herein by reference in their entirety.

### BACKGROUND OF THE INVENTION

Nanoscale-sized manipulator designs having large ranges of motions in all six degrees of freedom include a Stewart platform (Drexler (1992) Nanosystems: Molecular Machinery, Manufacturing, and Computation. John Wiley & Sons, Inc., New York, N.Y.), a serial robot with mechanical bearings (Drexler (1992) supra), a double tripod (Merkle (1997) Nanotechnology 8:47) and a modified Stewart platform with eight cranks (Drexler, et al., world-wide web imm.org/Parts/Parts2 with the extension html). Such designs have traditional mechanical rotary or translational joints that are difficult to fabricate and control due to friction. The modified Stewart platform (Freitas (1999) Nanomedicine, Volume I: Basic Capabilities. Landes Bioscience, Austin, Tex.) is a 2,596-atom fine-motion controller consisting of a shaft linking two hexagonal endplates, sandwiching a stack of eight rings to make a modified Stewart platform. Each ring supports a strut to a central platform. Two struts have been added to increase stiffness. The primary disadvantage of this design is adequate range of motion without mechanical interference or unacceptable bond strains. Scaling laws in mechanical friction, backlash, and fabrication have also presented problems.

Friction and backlash in kinematic chains have been addressed resulting in ultra-precision positional systems and devices. In these designs, traditional movable joints have been replaced by flexural joints with limited range of motion with respect to the overall dimensions of the device. Therefore, the limited range of motion due to the flexure joint and an increased complexity in design, if a large range of motion is to be accumulated through repeated use of the flexure joints, are disadvantages of these designs.

In principle, microscopes can modify or manipulate specimens being viewed (Jones (2004) Soft Machines—Nanotechnology and Life. Oxford University Press, New York, N.Y.). A modified electron microscope, for example, can write patterns directly into a material designed to be easily damaged by the radiation of an electron beam. In addition, scanning probe microscopses (SPMs) have been used to alter matter atom by atom (Eigler and Schweizer (1990) Nature 18:524; Requicha (1999) Nanorobotics, in Handbook of Industrial Robotics, S.Y. Nof, Editor, John Wiley & Sons, Inc.). Further, a light microscope can be turned into optical (laser) tweezers to manipulate a single DNA molecule (Perkins, et al. (1994) Science 264:819). The optical tweezers technique enables the manipulation of atoms and molecules without being hindered by the sticky finger, or ‘boxing glove’ problem in nanomanipulation (Chu (February 1992) Sci. Am. 71; Cohen-Tannoudji and Phillips (October 1990) Physics Today 33; Phillips and Metcalf (March 1987) Sci. Am. 36).

One shortcoming of most of these microscope-based manipulation tools is that they are restricted to the top-view surface of a specimen being observed (Jones (2004) supra). The physical size of the positioning systems used in the microscopes compared with the three-dimensional nanoscale features of the specimen limits ‘full’ observation and ‘full freedom’ manipulation around the nanoscale features on a specimen. This is reflected by the low lateral resolution compared with the vertical or top view resolution in most types of microscopes including scanning tunneling microscopes (STMs) (Binnig and Gerber (1986) Phys. Rev. Lett. 56:930; Bining and Rohrer (1982) Helvetica Physica Acta 55). This low lateral resolution problem has also been observed in atomic force microscopes (AFMs) (Smith and Chetwynd (1992) Foundations of Ultraprecision Mechanism Design. Gordon and Breach Science Publishers, New York, N.Y.), and is still a problem as the probes and beams cannot be rotated locally around the three-dimensional features of a specimen with large angles of rotation (Postek (Sep. 8-12, 2004) Research Directions II Report—Grand Challenge Workshop on Instrumentation and Metrology, NIST).

Bottom-up nanomanipulation tools and nanorobots based on the principle of self-assembly have been suggested. These include the DNA biped walker (Sherman and Seeman (2004) Nano Lett. 47:1203), atom-by-atom positioning on surface (Eigler and Schweizer (1990) supra), singling out a DNA molecule using optical tweezers (Perkins, et al. (1994) supra; Chu (February 1992) supra), path planning for automatic atomic positioning (Requicha (1999) supra) and a chemically-driven molecular lift (Balzani, et al. (2003) Molecular Devices and Machines—A Journey into the Nano World. Wiley-VCH, Weiheim). Difficulties with these approaches include the limited degrees of freedom and range of motion.

Precision positioning systems have been designed for SPMs (Fisher, et al. (2005) Nanomanipulator Measurements of the Mechanics of Nanostructures and Nanocomposites, in Applied Physics of Nanotubes: Fundamentals of Theory, Optics and Transport Devices, Rotkin and Subramoney, Eds.). Designs of this type are based on top-down approaches which attempt to miniaturize the device size in order for the system to be compatible for use within an electron microscope. Such nanomanipulator designs are dominated by X-Y-Z translational motions controlled by various picomotors and piezoactuators. While such devices have been utilized in a number of fundamental nanoscale manipulation and characterization studies (Falvo, et al. (1997) Nature 389:582; Salvetat, et al. (1999) Applied Physics A 69:255; Salvetat, et al. (1999) Phys. Rev. Lett. 82:944; Yu, et al. (2000) Phys. Rev. Lett. 84:5552; Yu, et al. (2000) Science 287:637; Yu, et al. (2000) J. Phys. Chem. B 104:8764; Pan, et al. (1999) Appl. Phys. Lett. 74:3152; Chen, et al. (2003) Nano Lett. 3:1299; Ding, et al. (2003) Nano Lett. 3:1593), further miniaturization of these designs for in situ applications has proven difficult.

An alternative approach for nanomanipulator design is based on the design and fabrication of MEMS-based machines and devices (Greywall, et al. (2003) J. Microelectromechanical Systems 12:708). While these devices can be made at a much smaller scale (Lu, et al. (2004) Rev. Scientific Instruments 75:2151.), MEMS-based designs are limited in their ability to deliver a large range of motion with full six degrees of freedom control.

Designs including the HexFlex™-based six-axis nano-manipulator (Culpepper and Anderson (2004) Prec. Eng. 28:469-482) have been suggested for use as microscale nanopositioners; however, the etched legs of these devices are brittle and provide a small range of motion.

Needed is a manipulator device suitable for nano, meso, and micro applications that provides multi-degrees of freedom, large range of motion in all its degrees of freedom, limited friction and backlash, and ease of fabrication and assembly of the components. The present invention meets this long-felt need.

### SUMMARY OF THE INVENTION

The present invention is a flexible parallel manipulator device. The device is composed of a top platform having a plurality of elastic fiber legs attached thereto, wherein at least one actuator is attached to the bottom of at least one leg so that the leg can be actuated and the top platform can be manipulated. In one embodiment, the device further employs at least one guide for at least one of the plurality of elastic fiber legs.

The present invention is also a method for providing angular or translational motion to an object. The method involves mounting an object to the top platform of a device of the present invention and moving an actuator thereof, thereby providing angular or translational motion to the object.

### BRIEF DESCRIPTION OF THE DRAWINGS

FIG. 1 shows a jointless device of the present invention with friction- and backlash-free six degrees of freedom motion. FIG. 1A, the device is composed of a top platform 10, a plurality of elastic fiber legs 20, and bases 30 attached to each leg. FIG. 1B, motion of top platform 10 driven vertically by the actuator bases 30 attached to each leg 20. Shown is a particular configuration with six elastic legs. The device is actuated with six vertical actuators and the top platform can move with six-degrees of freedom with the coordinated actuation of the six actuators.

FIG. 2 shows three examples for configuring six legs 20 and six actuators 30 of the instant device. FIG. 2A, six vertical actuators (vertical arrow). FIG. 2B, six horizontal actuators (horizontal arrow). FIG. 2C, flat configuration with horizontal actuators (horizontal arrow) fabricated with surface fabrication method and lifted (dashed arrow) by surface motors.

FIG. 3 depicts guides for facilitating motion control of the instant device. FIG. 3A shows rigid (left) and elastic (right) hollow tubes 40 as guides. The number of guides can vary with one guide 40 per leg 20 (left) or three guides 40 for six legs 20 (right). FIG. 3B depicts a particular configuration where the legs 20 are guided by three elastic guides 40 inside a large elastic tube 50. FIG. 3C shows integrated guides. The guide 40 can be hollow inside 42 (left) and made of a soft elastic material 44 to keep the legs 20 separated (right). The legs can slide along the integrated guide and the legs can be made of different materials (indicated by differences in shading).

FIG. 4 depicts the use of various actuators 30 in the device of the instant invention. FIG. 4A, top view of six MEMS-based vertical comb drives. FIG. 4B, front view of six MEMS-based vertical (Z) comb drives. FIG. 4C, top view of six MEMS-based horizontal (X) comb drives. FIG. 4D, top view of six vertical piezoelectric actuators. FIG. 4E, a group of nanomanipulators driven by vertical piezoelectric actuators.

### DETAILED DESCRIPTION OF THE INVENTION

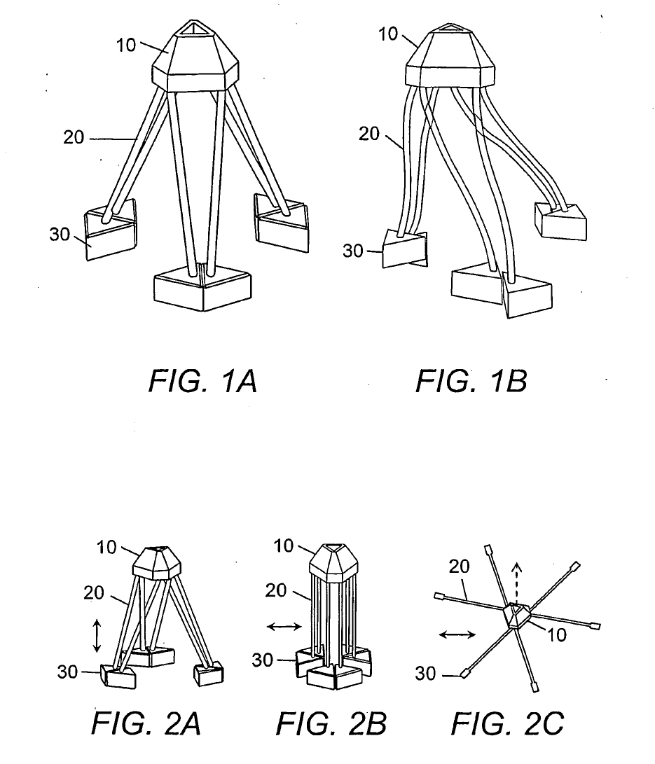

The present invention is a flexible parallel manipulator device based on the jointless motion mechanism commonly found in nature, e.g., cilia and flagella. The jointless manipulator disclosed herein is advantageously scalable and can be used for nano-, meso- or macro-manipulation as it provides friction- and backlash-free, multi-degrees of freedom motion. Referring to FIG. 1, the flexible parallel manipulator device is composed of a plurality of independent elastic fiber legs 20 which are attached, welded or bonded using standard joining methods (e.g., fusion welding, solid-state welding, brazing, soldering, adhesive bonding, and mechanical fastening or clamping) to a top platform 10 at various locations. In particular embodiments, the device has at least two elastic fiber legs, three elastic fiber legs, four elastic fiber legs, five elastic fiber legs, or more than six elastic fiber legs. In other embodiments, the device has at least six elastic fiber legs (see, e.g., FIG. 1).

In some embodiments, the cross section of the leg varies over the length of the leg; e.g., the diameter of a round leg can be more narrow at the end attached to the top platform than at the end attached to the base. In other embodiments, the shape of a leg at its starting position (i.e., before actuation) is not straight. In particular embodiments, the elastic legs are fibers (e.g., functional fibers, nanotubes, threads, or nanowires). As used in the conventional sense, “fiber” refers a class of materials that are continuous filaments or are in discrete elongated pieces, similar to lengths of thread. A fiber of the invention has a circular or smooth cross section and a smooth surface because of its manufacturing processes. The smooth surface conditions of the fiber have a strong influence on its high yield strength and fatigue strength. This is in contrast to beams of semiconductor materials produced by various micromachining processes. Such semiconductor beams have a rectangular cross section with damaged surfaces resulting from micromachining processes. The surface damages on the beam surfaces tend to initiate cracks and result in beam fracture and low fatigue strength. The differences in manufacturing processes and surface conditions result in a substantial difference in the strength, and fatigue resistance between fibers and micro-machined beams. See, e.g., Fitzgerald (2000) Crack Growth Phenomena in Micro-Machined Single Crystal Silicon and Design Implications for Micro Electro Mechanical Systems (MEMS), PhD Dissertation, Stanford University, pgs. 3-8. Fibers can take the form of long, continuous filaments or can be short fibers of uniform or random length. Moreover, the fiber legs can be any diameter or length depending on the size of the device and application.

The motion of the flexible parallel manipulator device is realized through the large elastic deflection of each individual elastic leg. The maximum strain of an elastic leg is in the elastic regain of the material's stress-strain curve so deformation will fully recover. This elastic deformation is also called compliance, and is designed to transmit motion and force to the top platform. As the elastic deformation is distributed over the entire length of a leg, large angular elastic deformation can be achieved from accumulated deformation along the leg. For a given material, the accumulated elastic deformation will be increased as the cross section of a leg is decreased. Even brittle materials can have significant elastic deformation. For example, a glass fiber of 50 micrometer can be bent into a small circle of about several millimeters in diameter, elastically. A variety of metal, or nonmetal materials such as plastic, silicon fibers, graphite fibers, or glass fibers having suitable elastic and physical properties can be used in the production of an elastic fiber leg of the instant device. For example, when a large elastic strain is desired, spring steel, super-elastic NiTinol (a shape memory alloy composed of nickel-titanium), or beta titanium can be used. Elastomers such as polyethylene, polypropylene, Nylon, PTFE, and polyaramid fibers, such as the fibers sold under the tradename KEVLAR, can also be employed as can metal or polymer matrix composites. Moreover, it is contemplated that one or more legs can be made of a different material. Advantageously, with fibers as legs, the range of motion for the instant device is improved over prior art devices having legs produced using deep reactive ion etching process on semiconductor material. For example, the instant device can achieve an angular motion range up to 90°90°×90°, whereas the prior art flexible hexapod design called pHexFlex, has a maximum range of 1.1°×1.0°×1.9°.

In choosing a leg material, a high strength-to-modulus ratio is desirable to achieve a large compliance. To illustrate, Table 1 gives the physical properties of existing fiber materials that can be used as leg materials of the instant device.

TABLE 1

| | Tensile | Tensile | | | Specific |
|---|---|---|---|---|---|
| | Strength | Modulus | Density | Strength/Modulus | Strength |
| Material | (GPa) | (GPa) | (g/ccm) | Ratio (strain) | (GPa) |
| Carbon Fiber | 3.5 | 230 | 1.75 | 1.52% | 2.00 |
| High | 6.0 | 290 | 1.75 | 2.07% | 3.43 |
| Strength | | | | | |
| Carbon Fiber | | | | | |
| KEVLAR ® | 3.6 | 60 | 1.44 | 6.0% | 2.50 |
| Fiber | | | | | |
| E Glass | 3.4 | 22 | 2.60 | 15.45% | 1.31 |
| Fiber | | | | | |
| Carbon | ~100 | ~1000 | ~1.34 | ~10% | ~74 |
| Nanotube | | | | | |
| Steel | 1.3 | 210 | 7.87 | 0.62% | 0.17 |

Values are based on a comparison to high tensile steel.

As shown, the modulus and strength can be varied over a wide range by adjusting the material utilized to provide the desired characteristics. As shown, suitable materials exhibit a tensile strength in the range of about 1 GPa to 100 GPa and a tensile modulus in the rage of about 20 GPa to 1000 GPa.

The suitability of a material for a particular application can be ascertained by analyzing such parameters as the nonlinear elastic deflection of a loaded bar and the smallest possible radius of curvature of the elastic material. The nonlinear elastic deflection of a loaded bar, according to the Bernoulli-Euler law, can be described as the bending moment at any point of the bar which is proportional to the change in the curvature caused by the action of the load. The basic formula is:

r⁻¹=M/EI=dφ/ds (1)

where s is measured along the arc, r the radius of curvature, and φ the slope at s, M is bending moment, E is the Young's modulus, and I=πd⁴/64 the moment of inertia for the bar. Given that the radius of curvature is a function of the bar diameter, if the diameter of the bar is reduced by a factor of 10 the radius of curvature is reduced by 10³ for the same bending moment and material.

The maximum elastic strain in an elastic fiber under uniaxial stress is ∈₁=σₘₐₓ/E=Sₜₑₙₛᵢₗₑ/E and is shown in Table 1 for representative materials. For example, for a fiber 5 nm in diameter d_{fiber}, the smallest radius of curvature r for a fiber curved into a small circle is ∈₁=d_{fiber}/2r. For strains of 1%, 5%, and 10%, the smallest radius allowed is 250 nm, 50 nm, and 25 nm, respectively. See, for example, the elastic curvature for carbon nanotubes that has been observed experimentally (Harris (1999) Carbon Nanotubes and Related Structures: New Materials for the 21st Century. Cambridge University Press, Cambridge). This analysis shows that scaling laws favor large elastic deformation as fiber size is decreased.

Referring to FIG. 1A, an elastic fiber leg 20 of the instant device has attached thereto a base 30, wherein the bases of a plurality of legs can be arranged either vertically or horizontally, or a combination thereof. The base block of each elastic fiber leg can be considered as a rigid body. In one embodiment of the instant invention, the base block of an elastic fiber leg is an actuator such that the base block can be driven in each of the linear directions, each of the angular directions, or a combination thereof. How each base block 30 is driven results in different motions and performance for the top platform 10 (see FIG. 1B). This is similar to the actuating of 75 types of rigid body parallel robots designed for various applications (Merlet (2000) Parallel Robots, Kluwer Academic Publishers). In particular embodiments of the instant device, at least one actuator is attached to the bottom of at least one leg. In other embodiments, an actuator is attached to the bottom of each leg of the device. In yet other embodiments, the device has at least six legs with an actuator attached to each leg. For a given set of six legs, for example, there are numerous configurations for arranging the six actuators. The configurations also affect the performance of the instant device. Three example configurations are shown in FIG. 2.

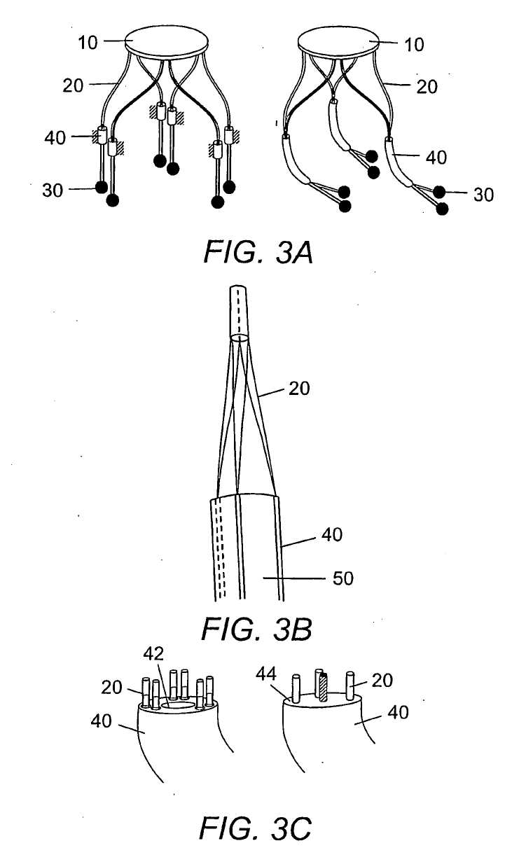

In one embodiment, the device of the instant invention further employs one or more guiding bearings 40 to facilitate motion control. A guide 40 can be, e.g., a rigid or elastic tube which is hollow inside (FIG. 3A) and can have various shapes. As with the number of legs of the device, the number of guides can vary and legs can share a guide (FIG. 3A). Further, the legs 20 can be guided by elastic guides 40 residing inside a larger elastic tube 50 (FIG. 3B). The guides 40 for the elastic fiber legs 20 can be integrated such that the legs can slide along the integrated guide. Integrated guides can be hollow 42 and made of soft elastic materials 44 to separate legs within the guide (FIG. 3C).

As the workspace of the disclosed device is scalable (e.g., microscale, mesoscale or nanoscale), if translational motions are the input motions, the ranges of motions of the actuators are also scalable (e.g., microscale, mesoscale or nanoscale). Suitable actuators for achieving angular, translational or combined motions include, but are not limited to, optical; electrostatic actuators such as comb drive (Selvakumar (2003) J. Microelectromechanical Systems 12) and scratch drive (Linderman and Bright (2001) Sensors and Actuators A 91:292); magnetic actuators (Verma (2004) IEEE/ASME Transactions on Mechatronics 9); piezoelectric actuator such as piezostack actuators (Smith and Chetwynd (1992) supra), piezoelectric ultrasonic motors (Peeters (2003) Proc. IEEE Int. Congress Acoustics Conference. Kyoto, Japan), surface acoustic wave actuators and micro standing wave ultrasonic actuator (Ferreira (2004) IEEE/ASME Transactions on Mechatronics 9); stick-slip actuators based on different actuation mechanisms (Bergander, in IEEE International Symposium on Micromechatronics and Human Science); bimorph actuators such as thin film PZT (piezoelectric) microcantilever (Zhu (2002) IEEE) and thermal actuators (Pichonat-Gallois (2003) The 12th International Conference on Solid State Sensors, Actuators and Microsystems Conference. Boston, Mass.); and shape memory alloy actuators (Berkelman (2002) in Proceedings of the 2002 IEEE International Conference on Robotics & Automation Conference. Washington, D.C.). Standard performance characteristics for a few types of actuators are summarized in Table 2.

TABLE 2

| | Drive | Current, | Force, | Range of |
|---|---|---|---|---|
| Type | Voltage, V | mA | μN | Motion, μm |
| Electrostatic | 20-80 | <0.1 | 50-1000 | 40-150 |
| Thermal | 3-8 | 5-100 | 500-3000 | >10 |
| Magnetic | 3-5 | 20-150 | 50-200 | >5 |
| Piezoelectric | 5-10 | <0.1 | 500-2000 | 20->150 |

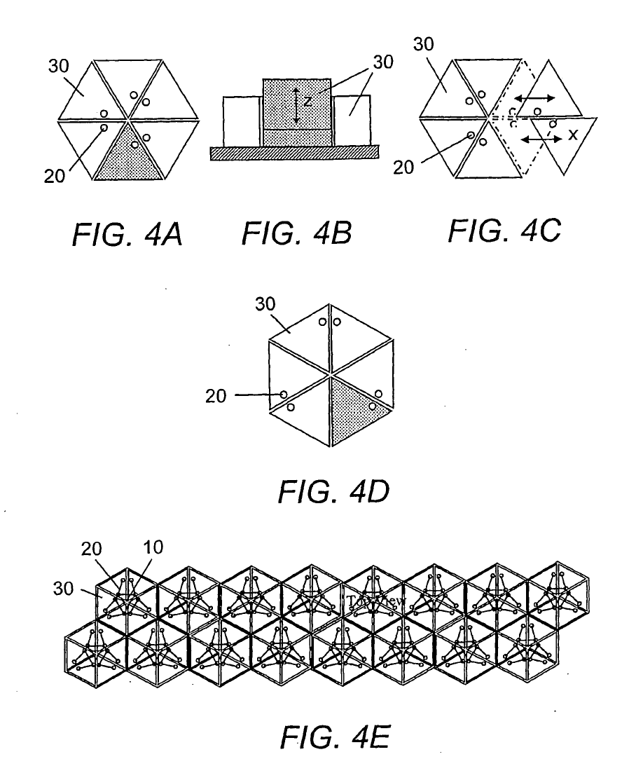

While many actuators can be used to drive the instant device, a particularly suitable actuator for a nanoscale device size manipulator is a piezoelectric actuator. A comb drive actuator is suitable for a microscale device-size manipulator. Both vertical and horizontal comb drives can be used with a variety of arrangements of the individual drives. See FIG. 4.

Similar to a single cantilever beam used in MEMS, the fundamental frequencies of a jointless device of the instant invention will increase as dimensions decrease. Thus, Jacobian analysis is performed to describe the stiffness properties of the instant device using stiffness matrix method. The stiffness matrix can also be used in system kinematic analysis, and system motion errors. Computational mode analysis has shown that the natural frequencies of a manipulator of microscale are at the level of megahertz, and gigahertz for manipulators of nanoscale. Analysis of the vibration modes of the instant manipulator (where the aspect ratio of the legs L/d=20:1=constant) shows that the fundamental frequency increases as a function of length scale from 1 Hz for units of m to 1.1 KHz (mm) to 1.5 Mhz (μm) to 1.5 GHz (nm). As the analysis is performed using E₀=200 GPa, and Density ρ₀=8000 Kg/m³, the frequency will be higher for most materials listed in Table 1. To estimate the frequency of a different material, the frequency data can be modified by a factor of \sqrt{(E/200)/(ρ/8000)}. The scaling law for the fundamental or natural frequency, based on the scaling laws for stiffness and mass (based on k∝l and m∝l³) is that the fundamental frequency will increase as the dimensions decrease (see also Table 2), i.e.,

f=(½π)\sqrt{k/m}∝l⁻¹ (2)

Thus, as the length scale decreases, both elastic deflection (Equation 1) and fundamental frequency (Equation 2) increase.

A device of the instant invention can be fabricated, e.g., using surface micromachining processes. The basic approach involves the addition and patterning of successive layers on a given substrate. Such processes are routine in the art in MEMS foundries (e.g., Cornell Nanofabrication Facility and the MIT Microsystems Technology Laboratory) The flat configuration of the nanomanipulators can be fabricated as planar structures and microassembled or “popped up” by actuating the comb drives to elevate the stage portion (see FIG. 2C, dashed arrow). The device can also be fabricated by assembling existing components. The assembly of the devices can be done using a standard precision XYZ fiber positioning system. A fully automatic fiber positioning system can also be used for mass production. Computer micro vision system and STM can be used for the visualization of assembly and testing of the device.

A device of the instant invention has numerous applications including autonomous molecular machine systems (Cavalcanti (2002) IEEE-Nano), molecular assembly manipulation for nanomedicine (Requicha (1999) supra; Freitas (1999) supra), nano-surgery system for cell organelles (Imura (2000) SICE Conference. Osaka, Japan), auto-focus systems in optics (Smith (2003) Proceedings of the 42nd IEEE Conference on Decision and Control Conference. Mani, Hi., USA), and automated alignment for scanning microscscopy Spanner (2003) Proceedings of the 2003 IEEE/ASME Internal Conference on Advanced Intelligent Mechatronics (AIM), Kobe, Japan). A defining characteristic of the device disclosed herein is the disruptive set of capabilities for in situ manipulation of an object on the top platform on the nanoscale, which will have application across the nanotechnology spectrum. In particular, it is advantageous to incorporate existing optical sensors with nanomanipulators of microscale device size to allow 3D in situ scanning or sensing applications to be accomplished. For example, optical tweezers for micromanipulation as well as near field optical microscopy for visualization in the nanometer regime will benefit from the use of the device disclosed herein. Since the first demonstration of trapping of dielectric particles in strongly focused light beams (Ashkin, et al. (1986) Opt Lett. 11:288), the potential of this technique for applications in micromachines, micromanipulation, chemistry and biology have been suggested (Ashkin (2000) IEEE J. Sel. Top. Quantum Electron. 6:841; Meiners and Quake (2000) Phys. Rev. Lett. 84:5014). Nonetheless, the range of optical tweezers has been limited to either a small volume or a structured pattern within this volume as the necessary optical field is typically focused by a high magnification microscope objective. This limits the use of optical tweezers for assembly of nanosystems. This restriction can now be overcome using fiber-based optical traps, allowing a free positioning of the trap in 3-D, in combination with the device of the instant invention. The trap is accomplished using superposition of multiple optical fields delivered by two or more fibers (Constable, et al. (1993) Opt. Lett. 18:1867) or a single fiber ending in a lens or modified tip (Taylor and Hnatovsky (2003) Opt. Exp 11:2775).

The combination of optical fibers together with the device of the invention can lead to a 3-D visualization of nanometer scale devices. Advantageously, the device of the instant invention would allow full six degrees of freedom positioning of the emitting and detecting fibers in the 3D space around and along the specimen.

The device of the instant invention can also be used as a specimen platform to enable real and full device observation within existing microscopes. This will extend the capability of existing microscopes from top/2D view to full device view. Further, the device can be used as an SPM probe carrier (or with a built-in probe) to enable in situ 3D nanoscale inspection. Given the compactness of the device, coordinated parallel 3D scanning is feasible.

With the actuators replaced by sensors for the legs, the device can also be used as 6-component nanoaccelerometers. Six elastic cantilever rods can support a mass vibrating with six degrees of freedom. The deflections could be monitored through changes in physical properties of the support legs (i.e., changes in electrical conductivity of carbon nanotubes or optical properties of optical fibers, respectively) allowing for the translational/angular accelerations of the mass to be determined. Moreover, when optical fibers are used as the elastic support legs, the optical functionality of the fibers can be utilized for both measurement and manipulation purposes, i.e., simultaneous vision feedback system such that motion of the nanomanipulator is in sync with the 3D vision, Optical tweezers could also be incorporated into the nanomanipulator design.

It is contemplated that a device of the present invention can be used alone or, alternatively, multiple devices can be used to provide coordinated flexible nanoautomation (see FIG. 4E). Coordinated motions can be programmed according to the kinematics developed for a particular device. For example, with numerous piezoelectric segments providing actuation, nanomanipulators with overlapped workspace can provide coordinated, cooperative motions similar to the processes of cilia in nature. With suitable end-effectors, flexible nanoautomation can build complex nanosystems at high production rates due to megahertz and gigahertz rates of manipulation.

What is claimed is:

1. A flexible parallel manipulator device comprising a top platform having a plurality of elastic fiber legs attached thereto, wherein at least one actuator is attached to the bottom of at least one leg so that the leg can be actuated thereby manipulating the top platform.

2. The device of claim 1, further comprising at least one guide for at least one of the plurality of elastic fiber legs.

3. A method for providing angular or translational motion to an object comprising mounting an object to the top platform of a device of claim 1 and moving an actuator thereof, thereby providing angular or translational motion to the object.
